(19) United States
(12) Patent Application Publication
(10) Pub. No.: US 2023/0139969 A1
(43) Pub. Date: May 4, 2023

(54) IDEMPOTENT RESOURCE MANAGEMENT SYSTEM PROVISIONING

(71) Applicant: SAP SE, Walldorf (DE)

(72) Inventors: Wei Chen, Shanghai (CN); Qiang Wu, Shanghai (CN)

(21) Appl. No.: 17/518,875

(22) Filed: Nov. 4, 2021

(51) Int. Cl. G06F 11/07; G06F 16/215; G06N 20/00

(52) U.S. Cl. CPC G06F 11/0793; G06F 11/0727; G06F 16/215; G06N 20/00

(57) ABSTRACT

Computer-readable media, methods, and systems are disclosed for provisioning within a resource management system. A request for provisioning is received and a related provisioning script is loaded. A command within the provisioning script is executed on a database. The database returns an error code. An operation type is determined for the command, and a remediation action is determined based on the error code and operation type. The remediation action is executed.

### BACKGROUND

A variety of resource management systems exist which each have unique characteristics. These resource management systems can be used to create and/or modify databases. Different databases also exist, with each database requiring different provisioning instructions which may be in different languages. Such existing resource management systems may receive provisioning instructions which fail for some or all databases.

Problems exist when provisioning of the resource management systems fails and provisioning needs to be attempted again. Manual techniques have been used to provision resource management systems, but such techniques are prone to error, time consuming, require high manual effort, and may vary based on the unique characteristics of each resource management system.

### SUMMARY

Disclosed embodiments of the present technology solve the above-mentioned problems by providing systems, methods, and computer-readable media for idempotent provisioning within a resource management system. Idempotency, or the ability to retry the same operation multiple times without varying results in subsequent retries, is crucial for the stability of cloud-based solutions. As such, idempotency is often required for Application Programming Interface (API) design. Resource provisioning is one such area in which idempotency is especially important.

A first embodiment is directed to one or more non-transitory computer-readable media storing computer-executable instructions that, when executed by a processor, perform a method for provisioning within a resource management system, the method comprising receiving a request for provisioning a database within the resource management system, loading a provisioning script containing one or more ordered commands, wherein the provisioning script is based in part on the request for provisioning, executing a command to take a provisioning action on the database, receiving an error code from the database in response to the command, determining an operation type for the command, determining a remediation action based in part on the error code received from the database and the operation type, and executing the remediation action.

A second embodiment is directed to a method for provisioning within a resource management system comprising receiving a request for provisioning a database within the resource management system, loading a provisioning script containing one or more ordered commands, wherein the provisioning script is based in part on the request for provisioning, executing a command to take a provisioning action on the database, receiving an error code from the database in response to the command, determining an operation type for the command, determining a remediation action based in part on the error code received from the database and the operation type, and executing the remediation action.

A third embodiment is directed to a system comprising at least one data processor and at least one non-transitory memory storing computer executable instructions that when executed by the at least one data processor cause the system to carry out actions comprising receiving a request for provisioning a database within the resource management system, loading a provisioning script containing one or more ordered commands, wherein the provisioning script is based in part on the request for provisioning, executing a command to take a provisioning action on the database, receiving an error code from the database in response to the command, determining an operation type for the command, determining a remediation action based in part on the error code received from the database and the operation type, and executing the remediation action.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary architecture relating to some embodiments;

FIG. 2 depicts a method for provisioning within a resource management system;

FIG. 3 depicts a method for provisioning within a resource management system;

FIG. 4 depicts an exemplary action configuration table; and

FIG. 5 depicts an exemplary hardware platform for embodiments.

The drawing figures do not limit the invention to the specific embodiments disclosed and described herein. The drawings are not necessarily to scale, emphasis instead being placed upon clearly illustrating the principles of the present teachings.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments are contemplated where a resource management system is used for idempotent provisioning. The resource management system is able to automatically interface with a variety of different databases and properly provision resources. If the resource management system encounters an error during provisioning, the resource management system automatically determines the appropriate responsive action based on the resource and operation type, and in some cases will automatically retry a failed command.

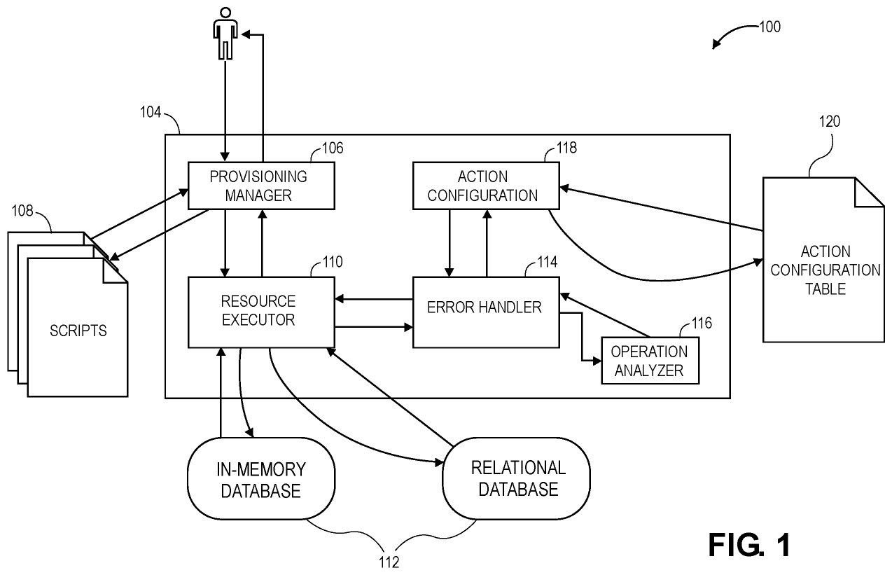

Turning first to FIG. 1, system 100 is depicted in an exemplary architecture relating to some embodiments. In such embodiments, system 100 includes resource management system 104. User 102 interacts with resource management system 104 to perform a provisioning action. In some embodiments, user 102 interacts with resource management system 104 to request performance of a provisioning action. For example, user 102 may wish to add a column to an existing in-memory database and pre-populate the column with default information. In some embodiments, provisioning manager 106 within resource management system 104 may contain one or more provisioning scripts 108. In other embodiments, provisioning scripts 108 may be external to resource management system 104 and accessed by provisioning manager 106.

Provisioning scripts 108 each contain one or more commands. In some embodiments, the commands could be in structured query language (SQL). Based on the user's request, provisioning manager 106 will select an appropriate provisioning script 108. For example, provisioning script 108 may contain two separate commands, a first command to add a column to an existing in-memory database and a second command to fill that column with a default value for all rows. The selected provisioning script is then passed to resource executor 110. Resource executor 110 interfaces with one or more databases 112 external to resource management system 104. In some embodiments, one or more of the databases 112 may be a HANA in-memory database from SAP. In further embodiments, one or more of the databases 112 may be a MySQL disk-based relational database. Databases 112 may be located at a local server, remote server, or other cloud configuration.

In some embodiments, resource executor 110 runs a first command from provisioning script 108 against the appropriate database 112. The appropriate database 112 is determined based on provisioning script 108. Resource executor 110 may receive back either a confirmation or an error message. If a confirmation is received, resource executor 110 continues to the next command within provisioning script 108. For example, if the command successfully creates a new column in an in-memory database 112, a next command, to auto-populate the column with default data, may then be executed. In some embodiments, if there are no other commands, resource executor 110 communicates a confirmation message to user 102. In some embodiments, such a confirmation message may pass through provisioning manager 106 before being communicated to user 102.

If resource executor 110 receives an error code from database 112, resource executor 110 may pass the error code to error handler 114. For example, if the column is not successfully created, database 112 may return an error code with a value of “308” indicating that the column already exists. As another example, database 112 may return an error code with a value of “11” indicating that there was an invalid state.

In some embodiments, error handler 114 uses operation analyzer 116 to determine an operation type that corresponds to the executed command. In some embodiments, error handler 114 passes a resource type, a scenario, and a command to be executed to operation analyzer 116. For example, the command could be a command to create a row in a database, the resource type could be an in-memory database, and the scenario would be an onboarding. In these embodiments, operation analyzer 116 determines based on the command and additional information that the operation type, or purpose of the command, is to add a column.

In some embodiments, operation analyzer 116 contains a mapping between resource type and classifiers. The classifiers may be used in part to decide the operation type based on a given command. In further embodiments, the operation type may be determined based on a classifier which is based in part on one or more grammar files provided to resource management system 104. For example, the grammar files may be formatted as Reverse Polish Notation (RPN) or as an Abstract Syntax Tree (AST). In still further embodiments, a lenient lexer may be used to generate a token sequence, filter out all inline comments, and then analyze the token sequence to understand the action. For example, if the lenient lexer generated a token sequence fora SQL command of “ALTER,” “TABLE,” “<TABLE_NAME>,” “DROP,” and “COLUMN,” the analysis could understand that the SQL command is dropping a column without needing to build a full RPN or AST. In even further embodiments, the operation type may be determined based on a trained artificial intelligence model which can create a classifier of an operation type based on a command. In other embodiments, the operation type may be determined based on a pattern provided to operation analyzer 116.

In some embodiments, error handler 114 passes the error code and operation type to action configuration module 118. Action configuration module 118 may determine an action to take based on the error code and operation type. In further embodiments, error handler 114 may additionally pass the resource type and the scenario to action configuration module 118. Action configuration module 118 may use an action configuration table 120 to determine the appropriate action to take. In some embodiments, action configuration table 120 may be located externally to resource management system 104. For example, if the command's operation type was to create a new column and the error code had a value of “308”, action configuration table 120 may instruct resource management system 104 that the error should be ignored. In this instance, the column already exists and so therefore provisioning script 108 can continue. As another example, if the command's operation type was to create a new column and the error code had a value of “11”, action configuration table 120 may instruct resource management system 104 that the command should be tried again. In this instance, the command may be rerun until the column is successfully created before provisioning script 108 continues.

In some embodiments, action configuration module 118 communicates to error handler 114 regarding which action to take. In other embodiments action configuration module 118 communicates the action to take directly to resource executor 110. In these embodiments, resource executor 110 then takes a corresponding action. In some embodiments, the actions available to take may be to ignore the error, to abort provisioning script 108, to retry the command, or to retry the command a certain number of times.

If the action to take is aborting provisioning script 108, resource executor 110 may stop running commands from provisioning script 108 and report the error message back to user 102. If the action is to ignore the error, resource executor 110 may ignore the error and run the next command within provisioning script 108. If the action to take is to retry the command, the command may be rerun until it is successfully executed. If the action to take is to retry the command a certain number of times, the action may be rerun a certain number of times before it will abort if it is unable to run successfully.

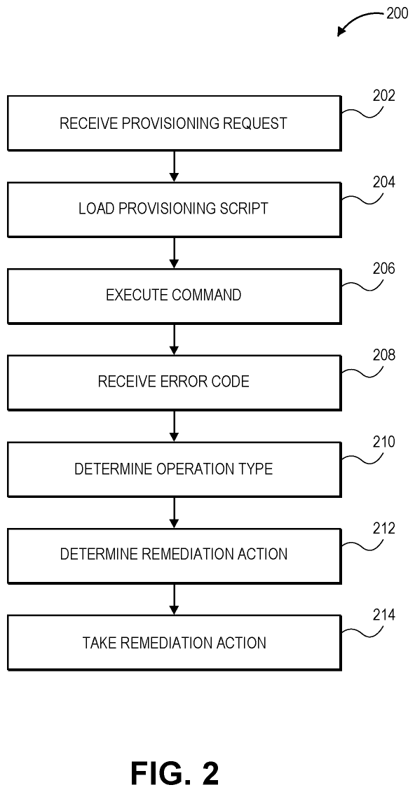

Turning now to FIG. 2, method 200 for provisioning within a resource management system is depicted relating to some embodiments. In some embodiments, the method may be performed by one or more processors associated with a resource management system server. In further embodiments the method may be performed on a computer. At step 202, a provisioning request is received. In some embodiments, the provisioning request may be submitted from a user. In further embodiments, the provisioning request may be submitted from a computer program or software. The provisioning request may involve on boarding, upgrading, or decommissioning a database, tables, or columns. In some embodiments, the provisioning request may involve generating new rows within a table. In further embodiments, the provisioning request may be in plain language.

At step 204, a provisioning script is loaded. Loading the provisioning script may involve reading the provisioning script into memory. In some embodiments, the provisioning script may be based in part on the received provisioning request. In further embodiments, the provisioning script may need to be converted to a suitable format such that it can be properly read as machine code. In still further embodiments, loading the provisioning script may involve transferring the provisioning script from one location in memory to another location in memory. For example, the provisioning script may instruct that files from two or more separate locations should both be loaded into memory.

At step 206, a command is executed. The command may be a command from the provisioning script. In some embodiments, the command may comprise a SQL command. For example, in a provisioning script to create a table, a command may be a SQL command such as “ALTER TABLE MYSCHEMA .EMPLOYEE ADD (c3 varchar(10));.” As another example, a subsequent command may be “ALTER TABLE MYSCHEMA .EMPLOYEE ADD CONSTRAINT my_constraint UNIQUE (c2);.” In further embodiments, the command may need to be formatted into a different language before being executed.

At step 208, an error code is received. In some embodiments, the error code may come directly from the database. The error codes may be generated in response to a command not executing as it is supposed to. For example, if a command attempts to create a table, but the table is not created, the database may generate an error code to indicate that the table was not created properly. The table may not have been created due to an improper command, an improper variable in the command, a network issue, or because the table already exists in that database. In some embodiments, the error code may indicate the specific reason the command failed to execute. In further embodiments, the error code may need to be reformatted or interpreted based on the response from the database. Additional information may be necessary to determine what caused an error code, which may be apparent from additional context. For example, if the error code is “308” additional context may be added to indicate that the error occurred because a command tried to create a table with a name, but a table with that name already existed.

At step 210, an operation type is determined. In some embodiments, the operation type is determined based on the executed command. In further embodiments, the operation type is further based in part on the resource type and a scenario. In some embodiments, the resource type may be determined based in part on one or more of the error code, database, scenario, and/or command. In further embodiments, the operation type may be determined using a machine learning model trained to identify the operation type based on the command.

At step 212, a remediation action is determined. In some embodiments, the remediation action may be to ignore, rerun, or abort. In further embodiments the remediation action may specify a limit to how many times the command may be rerun. The remediation action may be determined based in part on the error code and the operation type. In some embodiments, the remediation action may be further based on the resource type and the scenario. In further embodiments, the remediation action may be determined by accessing an action configuration table and looking up the corresponding stored remediation action. In still further embodiments, the remediation action may be determined using a trained machine learning model which is trained to generate an appropriate remediation action.

At step 214, a remediation action is performed. If the remediation action is to ignore the error, the method may proceed to the next command within the provisioning script and execute that command. If the remediation action is to abort, then the provisioning request will end. If the remediation action is to rerun, the command may be executed again, either repeatedly until it is successful or for a predetermined number of attempts. If no remediation action was determined, method 200 may default to aborting the provisioning script.

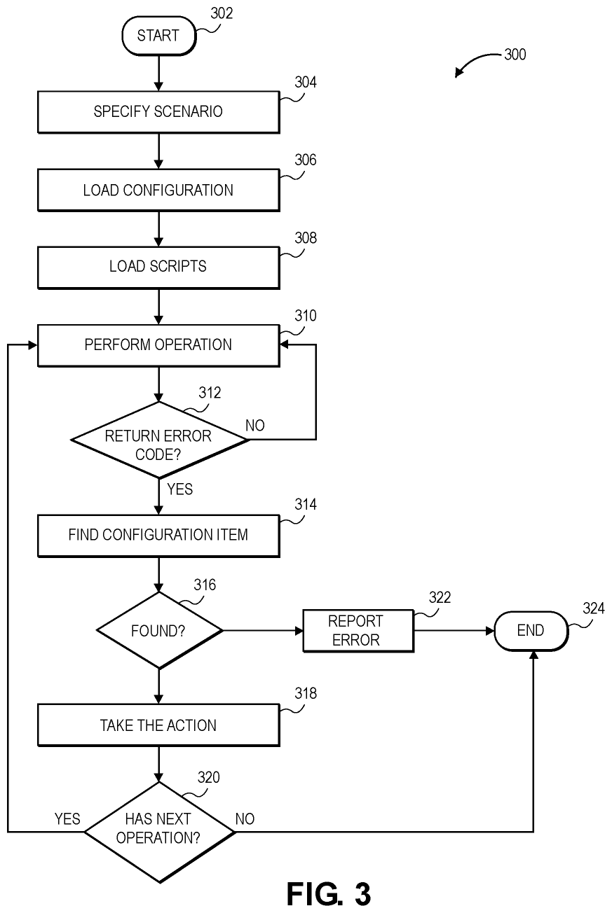

Turning now to FIG. 3, method 300 for provisioning within a resource management system is depicted relating to some embodiments. In some embodiments, the method may be performed by one or more processors associated with a resource management system server. In further embodiments the method may be performed on a computer. At step 302, method 300 is started. Method 300 may begin by a user requesting provisioning. In some embodiments, method 300 may be initiated by an automated system. For example, an automated system may automatically proceed to initiate method 300 multiple times with a series of commands to provision an entire database. Such automated provisioning may be used, for example, when migrating databases.

At step 304, a scenario is specified. The scenario may be any suitable provisioning scenario. For example, the scenario may be an onboarding, upgrade, or decommissioning within a database. In some embodiments, the scenario may be specified in part by a provisioning request. For example, a user may submit a provisioning request to add an additional column to an existing database, thereby specifying an onboarding scenario. In some embodiments, the user may explicitly specify the scenario. In other embodiments, the scenario may be determined based on a provisioning request.

At step 306, a configuration is loaded. In some embodiments, the configuration is an action configuration table which specifies which remediation actions should be taken in response to certain criteria. In further embodiments, a specific configuration is loaded based on which scenario is specified. In still further embodiments, the configuration may be loaded based in part on how the provisioning request was made. Loading a configuration may comprise downloading an action configuration table from external memory into local memory.

At step 308, one or more scripts are loaded. Each script may contain one or more commands which correspond to provisioning. In some embodiments, the scripts may be based on the scenario. In further embodiments, the scripts may be loaded from an external data source. The scripts may be provisioning scripts. In some embodiments, the number of scripts loaded may depend on which scenario was specified.

At step 310, an operation is performed. The performed operation may be in response to the loaded script. In some embodiments, the operation will be based on a command within the script. In further embodiments, the operation will be performed against a database. For example, one of the operations to be performed may be creating a new column within an existing database. Alternatively, or in addition, one of the operations to be performed may be to populate a column with default data. In some embodiments, the operation may be any possible action on a database which a database administrator may want to automate.

At step 312, it is determined if an error code was returned in response to the operation being performed. If no error code was returned, the method returns to step 310 such that another operation can be performed. If an error code is returned, the method proceeds to step 314. In some embodiments, the error code may be a set of alphanumeric characters. In further embodiments, the error code may be anything that is instructive as to the particular type of error that occurred when the operation was performed.

At step 314, the method attempts to find a configuration item. In some embodiments, searching for a configuration item comprises looking up a value in an action configuration table based on an error code. In further embodiments, finding a configuration item may comprise determining that no such value is available, and relying on a default configuration item. At step 316, it is determined if a configuration item was found. If a configuration item was found, the method proceeds to step 318. If no configuration item was found, the method proceeds to step 322.

At step 318, an action is taken. In some embodiments, the action is a remediation action. In further embodiments, the action taken is determined based on the configuration item. In some embodiments, the action may be the same as the operation previously performed at step 310. At step 320, it is determined if the script has another operation. If the script has another operation, the method returns to step 310 such that another operation can be performed. If the script does not have another operation, the method proceeds to step 324 and ends.

At step 322, the error is reported by communicating at least the error code to an entity. In some embodiments, reporting the error may involve sending a message to a user. In further embodiments, reporting the error may involve recording the error message in a system log. In still further embodiments, reporting the error may involve sending the error to a system administrator. In some embodiments, additional information such as the scenario, configuration, or operation performed may be communicated along with the error code. After the error is reported, the method proceeds to step 324 and ends.

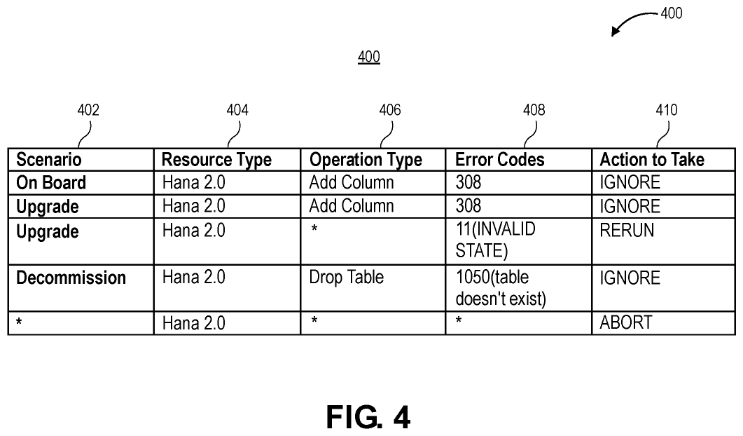

Turning now to FIG. 4, an exemplary action configuration table 400 is depicted. In some embodiments, an action configuration table may be stored in a database. In further embodiments, an action configuration table may be stored locally on a server or computer. While exemplary columns and data are provided, an action configuration table may contain a subset of the columns or additional columns depending on the specific embodiment.

Column 402 shows an example of a “scenario” column within an action configuration table. In some embodiments, the scenario corresponds to a class of provisioning. For example, provisioning scenarios may be on boarding, upgrading, or decommissioning. In some embodiments, some entries in action configuration table 400 may have wildcard designations for some columns. For example, an asterisk may be used to indicate that an entry is a wildcard. A wildcard entry will apply for a row regardless of what value a specific entry has for that column. For example, in action configuration table 400, a row may have a wildcard entry for all of the columns except resource type and action to take. Under this entry, if any scenario, operation type, and/or error code combination is not explicitly listed in action configuration table 400 for a resource type, such as Hana 2.0, then the listed action to take, such as abort, will be the default value for all commands with Hana 2.0 as the resource type.

Column 404 shows an example of a “resource type” column within an action configuration table. In some embodiments, the resource type may be an in-memory database. For example, the resource type may be a Hana database, including a specific version such as Hana 2.0. In further embodiments, the resource type may be a relational database. For example, the database may be a SQL database. In still further embodiments, any type of database, table, or reference may be a resource type.

Column 406 shows an example of an “operation type” column within an action configuration table. In some embodiments, the operation type may be to add a column, table, or database. In further embodiments, the operation type may be to drop a table or row or delete a database. In further embodiments, the operation type may be to insert a new row into a table and may include specific data to insert. In still further embodiments, the operation type may be any type of database management action which can be automated.

Column 408 shows an example of an “error codes” column within an action configuration table. In some embodiments, the error code may signify that the action did not occur. In further embodiments, the error code may signify that the action was not able to complete successfully. In still further embodiments, the error code may signify that the action could not occur because a database, table, row, or column does not exist. In still even further embodiments, the error code may signify that the user lacks the appropriate administrative privileges to perform the action.

Column 410 shows an example of an “action to take” column within an action configuration table. In some embodiments, the actions to take are either to ignore the command, rerun the command, rerun the command a certain number of times, or to abort the provisioning altogether.

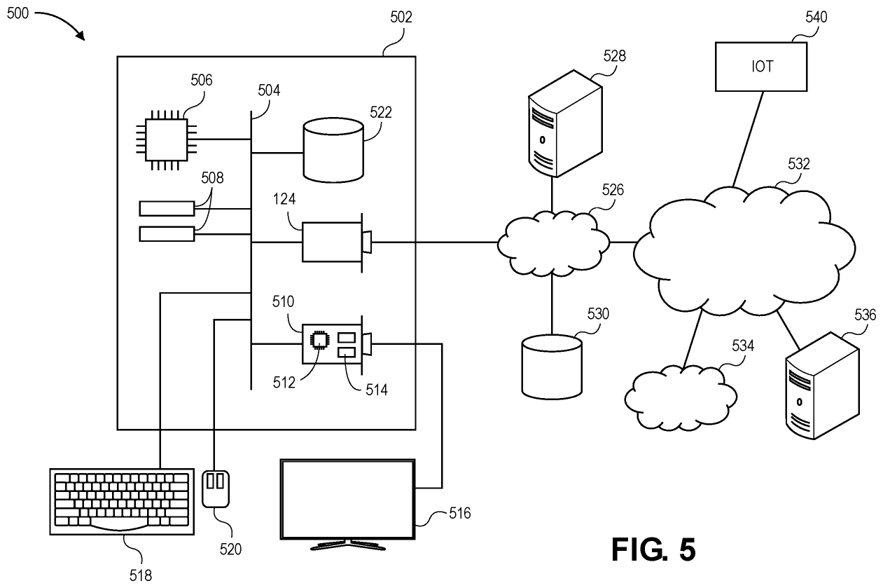

FIG. 5 depicts an exemplary hardware platform that can form one element of certain embodiments of the technology, referred to generally by reference numeral 500. Computer 502 can be a desktop computer, a laptop computer, a server computer, a mobile device such as a smartphone or tablet, or any other form factor of general- or special-purpose computing device. Depicted with computer 502 are several components, for illustrative purposes. In some embodiments, certain components may be arranged differently or absent. Additional components may also be present. Included in computer 502 is system bus 504, whereby other components of computer 502 can communicate with each other. In certain embodiments, there may be multiple busses or components that may communicate with each other directly. Connected to system bus 504 is central processing unit (CPU) 506. Also attached to system bus 504 are one or more random-access memory (RAM) modules 508. The RAM modules 508 may also be integrated into the CPU 506. Also attached to system bus 504 is graphics card 510. In some embodiments, graphics card 510 may not be a physically separate card, but rather may be integrated into the motherboard or the CPU 506. In some embodiments, graphics card 510 has a separate graphics-processing unit (GPU) 512, which can be used for graphics processing or for general purpose computing (GPGPU). Also on graphics card 510 is GPU memory 514. Connected (directly or indirectly) to graphics card 510 is display 516 for user interaction. In some embodiments no display is present, while in others it is integrated into computer 502. Similarly, peripherals such as keyboard 518 and mouse 520 are connected to system bus 504. Like display 516, these peripherals may be integrated into computer 502 or absent. Also connected to system bus 504 is local storage 522, which may be any form of computer-readable media and may be internally installed in computer 502 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 524 is also attached to system bus 504 and allows computer 502 to communicate over a network such as network 526. NIC 524 can be any form of network interface known in the art, such as Ethernet, ATM, fiber, Bluetooth, or Wi-Fi (i.e., the IEEE 802.11 family of standards). NIC 524 connects computer 502 to local network 526, which may also include one or more other computers, such as computer 528, and network storage, such as data store 530. Generally, a data store such as data store 530 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 528, accessible on a local network such as local network 526, or remotely accessible over Internet 532. Local network 526 is in turn connected to Internet 532, which connects many networks such as local network 526, remote network 534 or directly attached computers such as computer 536. In some embodiments, computer 502 can itself be directly connected to Internet 532.

Although embodiments have been described with reference to the embodiments illustrated in the attached drawing figures, it is noted that equivalents may be employed and substitutions made herein without departing from the scope as recited in the claims.

Having thus described various embodiments, what is claimed as new and desired to be protected by Letters Patent includes the following:

1. One or more non-transitory computer-readable media storing computer-executable instructions that, when executed by a processor, perform a method for provisioning within a resource management system, the method comprising:
receiving a request for provisioning a database within the resource management system;
loading a provisioning script containing one or more ordered commands, wherein the provisioning script is based in part on the request for provisioning;
executing a command to take a provisioning action on the database;
receiving an error code from the database in response to the command;
determining an operation type for the command;
determining a remediation action based in part on the error code received from the database and the operation type; and
executing the remediation action.

2. The media of claim 1, wherein determining the operation type is based in part on the command, a resource type corresponding to the database, and a scenario corresponding to a type of the request for provisioning.

3. The media of claim 2, wherein determining the remediation action is further based in part on the resource type and the scenario.

4. The media of claim 1, further comprising:
receiving a remediation result from the database in response to the remediation action;
sending the remediation result to a user of the resource management system.

5. The media of claim 1, wherein the remediation action comprises executing the command on the database again.

6. The media of claim 1, wherein determining the remediation action further comprises using an action configuration table which stores a plurality of possible remediation actions.

7. The media of claim 1, wherein determining an operation type is based in part on a trained machine-learning model.

8. A method for provisioning within a resource management system comprising:
receiving a request for provisioning a database within the resource management system;
loading a provisioning script containing one or more ordered commands, wherein the provisioning script is based in part on the request for provisioning;
executing a command to take a provisioning action on the database;
receiving an error code from the database in response to the command;
determining an operation type for the command;
determining a remediation action based in part on the error code received from the database and the operation type; and
executing the remediation action.

9. The method of claim 8, wherein determining the operation type is based in part on the command, a resource type corresponding to the database, and a scenario corresponding to a type of the request for provisioning.

10. The method of claim 9, wherein determining the remediation action is further based in part on the resource type and the scenario.

11. The method of claim 8, further comprising:
receiving a remediation result from the database in response to the remediation action;
sending the remediation result to a user of the resource management system.

12. The method of claim 8, wherein the remediation action comprises executing the command on the database again.

13. The method of claim 8, wherein determining the remediation action further comprises using an action configuration table which stores a plurality of possible remediation actions.

14. The method of claim 8, wherein determining an operation type is based in part on a trained machine-learning model.

15. A system comprising at least one data processor and at least one non-transitory memory storing computer executable instructions that when executed by the at least one data processor cause the system to carry out actions comprising:
receiving a request for provisioning a database within a resource management system;
loading a provisioning script containing one or more ordered commands, wherein the provisioning script is based in part on the request for provisioning;
executing a command to take a provisioning action on the database;
receiving an error code from the database in response to the command;
determining an operation type for the command;
determining a remediation action based in part on the error code received from the database and the operation type; and
executing the remediation action.

16. The system of claim 15, wherein determining the operation type is based in part on the command, a resource type corresponding to the database, and a scenario corresponding to a type of the request for provisioning .

17. The system of claim 16, wherein determining the remediation action is further based in part on the resource type and the scenario.

18. The system of claim 15, wherein the actions further comprise:
receiving a remediation result from the database in response to the remediation action;
sending the remediation result to a user of the resource management system.

19. The system of claim 15, wherein the remediation action comprises executing the command on the database again.

20. The system of claim 15, wherein determining the remediation action further comprises using an action configuration table which stores a plurality of possible remediation actions.
